(19) United States
(12) Patent Application Publication
(10) Pub. No.: US 2023/0264207 A1
(43) Pub. Date: Aug. 24, 2023

(54) DYNAMICALLY CONTROLLABLE SPRAY NOZZLE, CONTROL SYSTEM, AND METHOD

(71) Applicant: OGIVE TECHNOLOGY, INC., Davis, CA (US)

(72) Inventors: Durham Kenimer GILES, Davis, CA (US); Andrew J. HOLTZ, Salinas, CA (US)

(21) Appl. No.: 18/138,868

(22) Filed: Apr. 25, 2023

Related U.S. Application Data
(63) Continuation of application No. PCT/US2021/057131, filed on Oct. 28, 2021.
(60) Provisional application No. 63/107,043, filed on Oct. 29, 2020.

(51) Int. Cl. B05B 1/12; B05B 12/12; A01M 7/00

(52) U.S. Cl. CPC B05B 1/12; A01M 7/0089; B05B 12/12

(57) ABSTRACT

A dynamically-controllable spray nozzle, and associated control system and methods of use, has applicability in agricultural spraying and in other processes and devices in which spray nozzles are used. In an embodiment, a deformable nozzle may be compressed by one or more actuators to alter a nozzle’s exit orifice in a continuously variable manner.

### CROSS-REFERENCE TO RELATED APPLICATIONS

The present application is a continuation of PCT Application No. PCT/US2021/057131, filed Oct. 28, 2021, which in turn claims the benefit of U.S. Provisional Application No. 63/107,043, filed Oct. 29, 2020. The present application incorporates both of these applications by reference in their entirety.

### FIELD OF THE INVENTION

Aspects of the present invention relate to a dynamically-controllable spray nozzle, and associated control system and methods of use. The invention has use in application of chemicals for agricultural and other purposes, and in processes and devices in which spray nozzles may be used.

### BACKGROUND OF THE INVENTION

There are applications such as agriculture in which it is desirable to supply materials, such as bioactive agents (including agrochemicals) accurately and efficiently. A concept known as precision farming has been developed to achieve such goals, thereby avoiding problems such as chemical over-application, misapplication, runoff into potable water supplies, and airborne drift. These problems pose threats to humans and animals, other sensitive organisms, adjacent crops, and the overall environment. Inability to exclude spray movement precisely or to provide deposition of these bioactive agents on an intended target can result in overapplication of the agents. Such overapplication can result in excessive expense for a farmer and excessive use of limited energy resources with consequent further emission of greenhouse gases into the environment.

Spraying systems, particularly in agricultural applications, have been limited in operational range, capability, and effect because of the fixed nature of spray nozzles. Such nozzles have had static configurations and fixed exit orifices. Once installed, these nozzles lock in the system to a defined, unalterable set of spray features (flow rate (referring generally herein to the volumetric or gravimetric rate at which liquid passes through the spray nozzle), spray pattern, droplet size, and the like) which are optimal for only limited conditions and/or performance objectives. If the conditions and/or objectives change, for example, wind speed changes and/or a higher flow rate is desired, the fixed design of the nozzle is a limiting factor for dynamic, optimal control. Such is the case with modern agricultural chemical application. The dynamic nature of spraying, where application rates are optimized for geographic location and crop characteristics and sensed in real time, demand that the nozzles and fluid handling system have both a high degree of control range of the spray characteristics and a rapid temporal response.

Much effort has been directed toward controlling spray features such as flow rate, spray patterns (referring generally herein to spatial distribution of the emitted spray downstream of a nozzle’s exit orifice), droplet sizes, and droplet volume coming from a spray nozzle. Agricultural spray technology development in particular reflects this effort, as seen for example in USP 5,134,961, 5,653,389 and 5,704,546. The effort has produced numerous different nozzle configurations, with exit orifices and through-holes of different shapes and sizes, but each of these spray nozzles has had a single fixed and static configuration. A single, fixed, or static configuration nozzle is limited in the output spray features that it can provide. Altering flow rate, spray pattern and/or droplet size with such nozzles has had to come from application of differing amounts of pressure to the liquid as supplied to the nozzle, the effects of which are limited and may be insufficient. Different spraying conditions often require different nozzles, in turn requiring nozzle changes, often in the middle of a spraying operation. As a result, the spraying operation can be inefficient and/or ineffective, because of stops and starts necessary for nozzle changes or the spray hardware can become complex and costly as mechanical systems and actuators to change nozzles must be added to the system. These interruptions can be detrimental in precision spraying, for example, where the goal is to provide specific amounts of the agent in particular areas within a limited time. Known approaches to reducing the effect of these interruptions have involved switching of flow from one nozzle to other nozzles, as described, for example, in USP 9,884,330.

Known approaches to control flow rate through a nozzle, particularly in agricultural applications, may employ direct pressure control and/or the provision of a fixed or variable pre-orifice in front of the nozzle. Such approaches have provided limited flow control range, limited control stability, and limited capability to provide individual nozzle control. Direct pressure control has several disadvantages in terms of spray coverage:
Flow rate from a fixed exit orifice is proportional to the square root of pressure; consequently, achieving a useful flow control range requires extreme changes in pressure;
Changing pressure changes spray droplet size spectrum and spray spatial distribution pattern, often in an undesirable fashion;
Limitations in the liquid supply system may allow only a relatively narrow range of pressure variation and control, hence greatly limiting the ratio of the maximum possible flow rate to the minimum possible flow rate (a ratio known as the turndown ratio);
Pressure adjustments are provided to all of the operating nozzles in a system and not just on individual nozzles, potentially resulting in desirable control of some nozzles and undesirable control of other nozzles; and
Pressure adjustment systems are too slow for the modern ground speeds and spatial resolution needed in precision spraying.

A control system necessary to provide such direct pressure control also has been complex and correspondingly expensive. Further, such control systems have required significant power, for example, electrical, hydraulic or pneumatic sources from a vehicle or stationary source. Developments in pulse width modulation (PWM) control have ameliorated some of the foregoing problems with direct pressure control. PWM systems can provide a wider flow rate control range while retaining spray pattern and droplet size. These systems also can provide individual nozzle control, as well as a more linear control capability in which flow is directly proportional to duty cycle, among other things. PWM systems, however, have not addressed satisfactorily the limitations of existing spray nozzles and in some instances have not removed the need to provide liquid pressure control. Some nozzles also have constructions that make the nozzles relatively insensitive to liquid pressure, making even added liquid pressure control ineffective.

An additional limitation in the dynamic control of spray characteristics has been the time that it takes to make changes, e.g., in flow rate, spray pattern, droplet size, and the like. Complex electrical, hydraulic, or pneumatic control systems require time to implement an output change. The time lag between the physical manipulation of the pre-orifice or other structure upstream of the nozzle, and the resulting change in the flow rate, spray pattern, droplet size, and the like, limits their responsiveness and precision.

It would be desirable to provide a spray nozzle that enables systems and methods for improved and dynamic control of spray features, providing the ability to change spray output to suit a wide range of conditions without changing nozzles, and thereby move beyond the limitations of fixed configuration nozzles.

### SUMMARY OF THE INVENTION

To address the foregoing and other issues and problems, embodiments of the present invention make a spray nozzle’s configuration a control mechanism, providing a dynamically controllable spray nozzle. Through dynamic manipulation, the part of a spraying system which has been a limiting factor in optimization of spray features - the spray nozzle and in particular its exit orifice - can provide for control of flow rate, droplet size, and spray pattern to facilitate precision spraying.

According to embodiments of the present invention, a dynamically controllable spray nozzle and associated control system improve accuracy and efficiency of spraying processes, including in chemical applications for agricultural and other purposes, such as for management of crop pests, habitat or species (including invasive species), foliage control. In such applications, the nozzle may be suitable not only for spraying machinery, such as existing ground and aerial vehicles, but also for emerging technologies of robotic and intelligent sprayers, precision/sensing sprayers, and remotely piloted aircraft sprayers.

In embodiments, the dynamically controllable nozzle is sufficiently pliable so as to be deformable, resulting in alterations in shape of throughput and/or exit orifice(s) of the nozzle. In embodiments, the nozzle also is sufficiently resilient to resume the nozzle’s original shape when deformation force is not applied, even after repeated deformations. In embodiments, deformability occurs on a continuous basis to enable timely control of spray features, including spray flow rate, spray pattern, droplet size, and spray and droplet motion. The resulting structure avoids the need to change nozzles during spray procedures, thereby avoiding interruptions in spraying operations and the inefficiencies they cause. A single deformable nozzle can provide the same range of spray flow rates, spray patterns, droplet sizes, and spray and droplet motions as multiple fixed or static nozzles.

In embodiments, various types of actuators or micro-actuators, some embodiments employing piezo-active elements, may provide the appropriate deformation of the nozzle to shape the nozzle exit orifice(s) to provide desired flow rates, spray patterns, droplet sizes, and spray and droplet motions. Nozzle materials may be selected to allow actuation by devices such as piezo-active elements. The nozzle materials may be selected to provide one or more of low-cost, low power consumption, rapid response, and low mass.

### BRIEF DESCRIPTION OF THE DRAWINGS

FIGS. 1A and 1B show dynamically controllable nozzles according to embodiments.

FIG. 2 shows a dynamically controllable nozzle with a linear actuator according to an embodiment.

FIG. 3 is a graph showing nonlinear behavior during deformation according to an embodiment.

FIG. 4 shows a dynamically controllable nozzle with a linear actuator according to an embodiment, and aspects of operation thereof.

FIG. 5 shows the nozzle of FIG. 4 with a slight deformation according to an embodiment, and aspects of operation thereof.

FIG. 6 shows the nozzle of FIG. 5 with a further deformation according to an embodiment, and aspects of operation thereof.

FIG. 7 shows the nozzle of FIG. 6 with a still further deformation according to an embodiment, and aspects of operation thereof.

FIG. 8 shows the nozzle of FIG. 7 with a yet further deformation according to an embodiment, and aspects of operation thereof.

FIG. 9 is a high level diagram of a dynamically controllable nozzle system according to an embodiment.

FIG. 10 is a high level diagram of a dynamically controllable nozzle system according to an embodiment.

FIG. 11 is a diagram of a controller for a dynamically controllable nozzle system according to an embodiment.

FIGS. 12A and 12B show a comparison of flow rate as a function of droplet size with individual nozzles, and with nozzles according to embodiments.

FIG. 13 shows an agricultural sprayer according to embodiments.

FIG. 14 shows a droplet size and flow rate control mechanism according to embodiments.

### DETAILED DESCRIPTION OF EMBODIMENTS

Aspects of the invention include a deformable, dynamically-controllable nozzle, with homogenous or heterogeneous material properties, allowing deformations to alter spray features, including flow rates, droplet sizes, and spray patterns and/or aiming of spray, and one or more actuators, to translate movement of one or more contact surfaces of the actuator toward the nozzle to effect such deformation. Nozzle deformation can include deformation of the exit orifice, for example, elliptical and/or curvilinear alterations in exit orifice shape. Embodiments can include nozzle deformation in the form of deformation of other portion(s) of the nozzle. In embodiments, industry standard pressure and pulse width modulated (PWM) control systems may provide supplemental or complementary control of the nozzle to achieve defined spray features such as flow rate, droplet size, and spray pattern. Geometry of the exit orifice(s), and the resulting spray features, may be actively controlled to optimize spray features, for example, according to varying conditions or changing objectives, during use and/or in a continuous fashion.

Aspects of the invention facilitate function and operation of precision spray systems such as target-sensing chemical sprayers and unmanned aircraft, as well as more conventional ground-based and air-based agricultural spray systems.

Embodiments of the present invention provide a dynamically-controllable spray nozzle wherein portion(s) of a through-hole in the nozzle, and in particular the exit orifice, may function as a control mechanism, for example, depending on the size or shape of the exit orifice. In some embodiments, the exit orifice may be the primary control mechanism. In this manner, a sensitive part of the spray system, i.e., the shape of the exit orifice, may be manipulated to produce a desired spray, for example, a desired flow rate, droplet size, and spray pattern. The spray features may be controlled to be substantially constant, for example, despite changes to the input (e.g. pressure) and/or changes in conditions (e.g. temperature, humidity) that would otherwise change the spray features, and/or to change, for example in a substantially continuous fashion during an application or in a non-continuous fashion, e.g. between applications.

Embodiments of the nozzle according to aspects of the present invention may comprise a strategically deformable material. Deformation of the material, for example to alter a shape of the nozzle’s exit orifice, may be effected by actuators such as micro-actuators embedded in, or coupled to, the nozzle. The nozzle material’s degree of deformability (which may be thought of or described as the required strain energy necessary to drive the nozzle through its operating range of motion) may affect the power requirements for the actuators. Depending on the embodiment, different types of actuators, such as bender linear actuators or in-line linear actuators, may be employed. A shape of the end of the selected actuator may be varied as desired. For example, the end may be shaped to interact with the nozzle only in a vicinity of the exit orifice. Additionally or alternatively, the end may be shaped to interact along a more substantial part of the through-hole of the nozzle, or even along the entire length or depth of the through-hole into the exit orifice. The shape of the end of the actuator may depend on such criteria as nozzle length, desired point(s) or areas of deformation of the nozzle to alter the shape of the exit orifice, selection of void and/or strategic weakness type and pattern in the nozzle, and other criteria which ordinarily skilled artisans will appreciate.

In embodiments, nozzles may be cut, stamped, sintered, compression molded, or 3-D printed, among other techniques.

In embodiments, movement of linear actuators for flow control may be effected via pulse width modulation (PWM). An example of PWM control may be found in USP 5,134,961. While PWM control has been limited by the fixed exit orifices of conventional spray nozzles, that limitation is no longer present with embodiments of the present invention providing variability of exit orifice size and shape.

In embodiments, a plurality of deformable nozzle systems (e.g. assemblies with the nozzle and accompanying actuator) may be provided on a boom, as ordinarily skilled artisans also will appreciate.

In an embodiment, actuators associated with a nozzle may be energized selectively, collectively, or to different degrees, so as to effectively aim a spray or jet toward a desired target.

In an embodiment, actuators associated with a nozzle may be energized so as to cause a spray or jet to sweep along a defined path. For example, an exit orifice can be deformed in one direction by energizing one actuator, causing a spray in one direction, and the exit orifice can then be deformed in a different direction by energizing a different actuator, causing the spray to be shifted in its direction, and so on. A spatially coherent sequence of energization of actuators may be used to change spray direction. This mode of operation can be useful in applications such as weed control along a seed line in a field.

In an embodiment, actuators associated with a plurality of nozzles, provided on a boom or other sprayer structure may be energized selectively, collectively, or to different degrees. For example, the actuators for one subset of the plurality of nozzles may be energized in one manner and the actuators for another subset of the plurality of nozzles may be energized in another manner. In an embodiment, actuators associated with a plurality of nozzles may be energized dynamically (e.g. in a spatially organized manner) so as to vary the collective properties of the collective spray from the plurality of nozzles.

In different embodiments, there may be one or more nozzle actuators, each including a microcontroller. One or more microcontrollers may be connected physically (wired) to actuator circuitry, or may be connected contactlessly (wirelessly) to the actuator circuitry. The controller may function as a stand-alone controller for some spray systems, and can be integrated, for example as an expansion, into other control systems such as PWM control systems. Supplementing control of the deformable nozzle with PWM control can provide improved control for precision spraying. For example, use of deformable nozzle(s) with PWM control can provide on-off control, while reducing or eliminating the disadvantage of pulsing spray and consequent non-uniform coverage that PWM control has provided, without having to provide a greater number of nozzles and a consequently more complex valve system and control system.

In an embodiment, an ability to enlarge or reduce nozzle characteristics (nozzle length, exit orifice and/or through-hole diameter, nozzle diameter, and the like) may be used in coordination with altering a pressure under which liquid is provided to form a spray, and also in coordination with the duty cycle of a PWM system in order to control velocity, kinetic energy and momentum of the resulting spray. Such a configuration and mode of operation may result in a three-dimensional control space in which spray features such as flow rate, droplet size, and spray pattern can be optimized for desired spraying conditions.

In embodiments, suitable nozzle materials may include various elastomers or other materials with Shore A hardnesses ranging from 40 to 90 for more flexible elements, and hardnesses more appropriately measured on the Shore D scale for more rigid elements.

In an embodiment, the materials may have non-homogeneous and/or anisotropic properties and/or nonlinear properties. For example, a nozzle may comprise two or more elastomeric materials, some softer, some harder, combining relatively flexible parts with relatively inflexible parts to create desired geometries and properties, or to provide more support along certain regions, such as a crown or edge of an exit orifice, or less support along certain regions, for example, in a mid-region of the nozzle or away from an exit orifice. In such embodiments, the one or more actuators may be positioned to effect forces strategically along a nozzle through-hole, for example, exerting force farther away from the exit orifice to shape one or more portions of the through-hole and exerting force closer to the exit orifice, for example, to shape the exit orifice.

In an embodiment, the exit orifice may be circular. Operation of the dynamically controllable system may alter a shape of the exit orifice, for example, causing it to be elliptical, with varying major and minor axes, based on pressure that one or more actuators applies to sides of the nozzle, whether throughout a length of the nozzle, in regions along a length of the nozzle, or in a vicinity of the exit orifice. Manipulation of the exit orifice, and in some instances part or parts of a nozzle through-hole leading to the exit orifice, enables the provision of the capability and performance a plurality of existing fixed nozzles in a single nozzle, with the ability of the inventive nozzle to replicate the physical exit orifice and pre-orifice dimensions of those fixed nozzles under appropriate control.

In the following discussion, materials for embodiments of the inventive nozzle, as well as the nozzle itself, may be described in terms of flexibility, deformability, and pliability. Usage of one of these terms instead of another does not convey difference in construction or operation, or selection of materials.

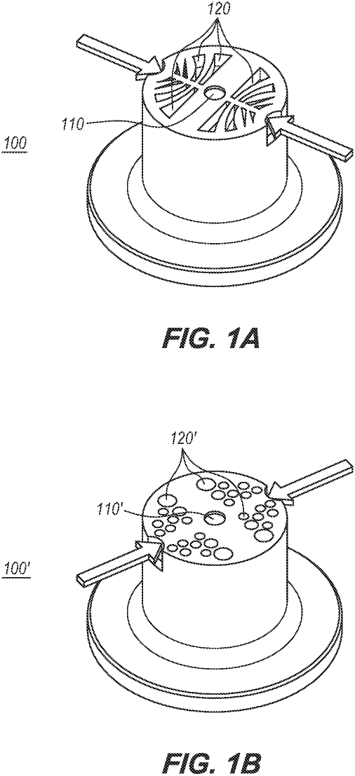

FIG. 1A depicts a deformable nozzle 100 with an exit orifice 110 at an end of a through-hole running through the nozzle. Internal voids or strategic weaknesses 120 in the nozzle material, around the exit orifice 110, assist in favorable deformation of the exit orifice. In different embodiments, force may be applied in the vicinity of the exit orifice to focus deformation at the exit orifice portion of the nozzle, or may be applied more generally to a through-hole extending throughout the nozzle to focus deformation elsewhere in the nozzle.

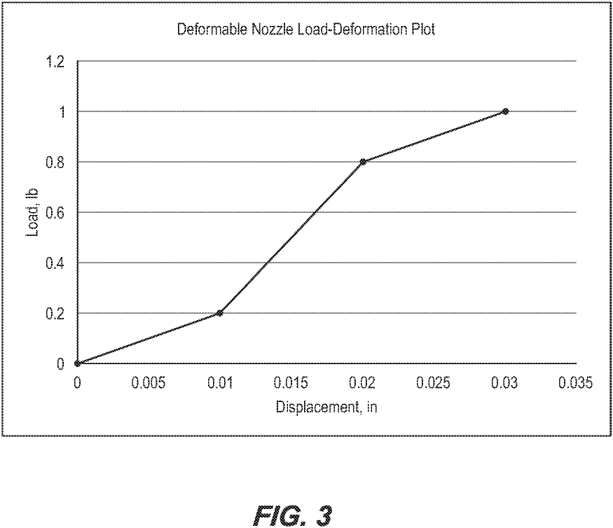

FIG. 1B shows a deformable nozzle 100′ with an exit orifice 110′ and a different shape and pattern of internal voids or strategic weaknesses 120′ around exit orifice 110′. In some embodiments, the void or strategic weakness patterns may be asymmetric. In other embodiments, the void or strategic weakness patterns may be symmetric. Ordinarily skilled artisans will appreciate that the appropriate void or strategic weakness pattern can contribute to favorable material properties, which may include the non-homogeneity and anisotropicity properties mentioned above and described further with respect to FIG. 3. Selection of the appropriate void or strategic weakness shape and/or pattern may vary depending on the nozzle material to provide the appropriate modulus of elasticity in the overall nozzle structure.

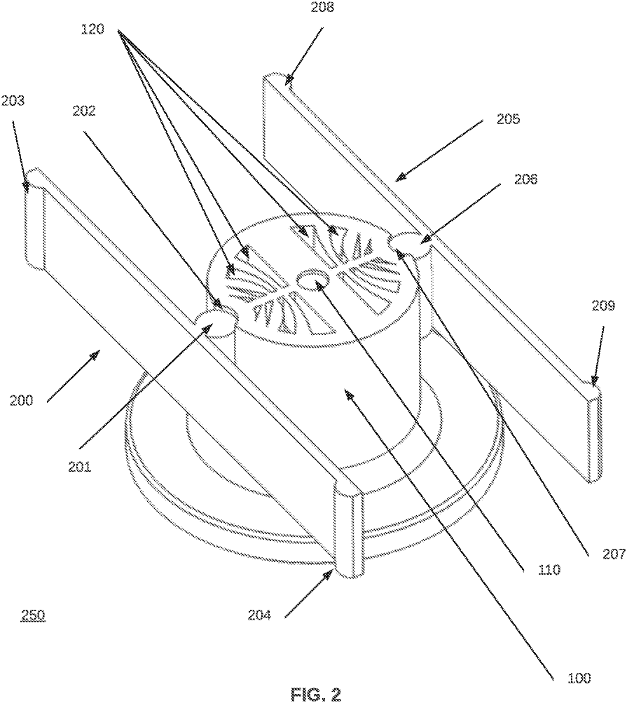

FIG. 2 is a depiction of an assembly 250 of a pair of actuators 200, 205 with a deformable nozzle 100 according to an embodiment. In FIG. 2, the actuators are piezo-electric bender linear actuators which translate bending motion into linear displacement, to create displacement and deformation of the inventive spray nozzle. Other types of linear actuators, for example in-line linear actuators, may be provided. Other types of actuators also may be used. Such actuators may comprise piezo-active elements. In some embodiments, piezo actuators may be fabricated into a stack. Some actuator designs can include an embedded strain gauge or other method to enable precise measurement of actuator motion.

There are other external or embedded actuators in the family of electro-active polymers (EAPs) or electroviscous fluids. Such fluids exhibit different properties. For example, EAPs are hyperelastic solids with a controllable input force. Electroviscous fluids are liquids exhibiting a variable shear strength.

In yet other embodiments, an actuator may be nonlinear, for example, a curved rotary actuator or other type of actuator that can convert linear motion into rotary or more complex motion. Such movement might follow a nonlinear or circular path. Such actuators may have multiple points or areas of contact with nozzle 100.

In the embodiment shown in FIG. 2, linear actuator 200 has a central contact surface 201 which fits into a recess 202 in nozzle 100. In other embodiments, an actuator may have multiple contact surfaces, for example two contact surfaces, for example equidistant from a central point, each of which fits into a recess in nozzle 100, or contacts a different portion of nozzle 100. Ends 203, 204 are deformable under application of an appropriate amount of current and/or voltage to urge central contact surface 201 against recess 202 to alter a shape of exit orifice 110 in nozzle 100. In an embodiment, central contact surface 201 is as long as a through-hole in nozzle 100. In an embodiment, central contact surface 201 may be short enough to affect only a vicinity of the exit orifice. Varying the length of central contact surface 201 can affect overall flow through the through-hole, and can affect pressure both in the through-hole and at the exit orifice.

In an embodiment, a shape of exit orifice 110 is circular. In other embodiments, a shape of exit orifice 110 is geometrical, for example, a triangle, a rectangle or square, a pentagon, or other polygonal shape, whether regular or irregular. In some embodiments, a shape of exit orifice 100 is irregular, e.g. an ellipsoid, trapezoid, other irregular polygon, or star shaped, whether a five-pointed star, a six-pointed star, or other shape. In such embodiments, a shape of the exit orifice may prompt differing numbers and placement of actuators around the exit orifice and/or around the through-hole.

Also in FIG. 2, actuator 205 has a central contact surface 206 that fits into a recess 207 in nozzle 100 according to an embodiment. Recess 207 may extend along the entire length of nozzle 100, or may extend along a portion of the nozzle. The actuator 205 may have a width corresponding to a length of recess 207. Recess 207 facilitates positioning of the central contact surface 206, but in some embodiments the recess may be omitted. In an embodiment, ends 208, 209 are deformable under application of an appropriate electrical input, including but not limited to an appropriate amount of current and/or voltage to urge central contact surface 206 linearly against recess 207 to alter a shape of exit orifice 110 in nozzle 100. In an embodiment, application of force by moving central contact surface 201 and/or 206 toward exit orifice 110 will cause a shape of exit orifice 110 to change, for example, from circular to elliptical, thus altering the spray features, for example, altering a shape of the spray coming out of exit orifice 110, directional bias of the spray, size of droplets in the spray, and the like. The application of force also will cause deformation of the voids or strategic weaknesses 120 in nozzle 100, also contributing to the alteration of spray feature and nozzle size.

FIG. 2 depicts the recesses 202, 207 positioned 180 degrees from each other in nozzle 100. The actuators 200, 205 provide force to compress the nozzle 100 in line from those recesses. Other positioning of the actuators, so that the central contact surfaces still fit within the recesses but the actuators provide force at a different angle other than straight toward a central location of the central contact surfaces, is possible. Also, for example, a pair of actuators can be positioned at obtuse, right, or even acute angles less than 180 degrees, for example, at a 120 degree, 90 degree, or 45 degree angle with respect to each other. While FIG. 2 shows two actuators, a single actuator or more than two actuators may be used. Where more than two actuators are used, they may be spaced equidistantly around the nozzle, or may be spaced irregularly. For example, three actuators could be at 120 degree intervals, or at different intervals. As another example, two of the three actuators could be 120 degrees apart, and the third actuator could be positioned at a different interval. As yet another example, four actuators could be positioned at 90 degree intervals, or at different intervals. As still another example, two or three of the four actuators could be 90 degrees apart, and the third and/or fourth actuator could be positioned at different intervals. Other relative angular positions of the recesses, and hence of the angles at which actuators may provide force to compress the nozzle, are possible depending on design need.

The location and number of actuators used can result in different spray shapes and droplet sizes being possible for the same nozzle. In one embodiment, fewer than all of the actuators can be used simultaneously. For example, there can be three actuators, and one, two or all of the three actuators can be used at a time to cause deformation. Using fewer than all of the actuators can provide control of the directionality of the spray, for example.

In an embodiment, nozzle deformation may be nonlinear with respect to actuator displacement. According to some embodiments, relatively small actuator displacements, yielding relatively small changes in nozzle and/or exit orifice shape, can yield a significant change in spray nozzle geometry and spray features.

In embodiments, the following factors may contribute to nonlinear nozzle deformation. One factor is the nozzle material itself, which may exhibit so-called hyperelasticity, meaning that in the course of deformation, the stress-strain relationship is nonlinear, including with inflection points. For such materials, a force/deflection curve might exhibit inflection points, meaning that a material under stress may stiffen, then soften, then stiffen again.

Another factor is the provision of the voids or strategic weaknesses. A given nozzle material might have relatively linear deformation properties, but the voids or strategic weaknesses cause the nozzle’s deformation properties to be nonlinear. The shape, pattern, and/or placement of voids or strategic weaknesses may contribute to, or otherwise modify, nonlinearity arising from the nature of the material.

FIG. 3 is an exemplary graph of how a nozzle’s load vs. deformation load v. deformation function may behave as the voids or weaknesses shown in FIGS. 1A, 1B and 2 collapse until they disappear. The graph shows successive increases in stiffness through the range of actuator displacement. Different patterns of voids and weaknesses will yield different graphs. In addition, materials exhibiting nonlinear properties even without the voids and weaknesses may yield load v. deformation graph that can resemble the graph of FIG. 3. Other materials and other voids and weaknesses patterns may yield a curve in whole or in part, rather than a series of lines.

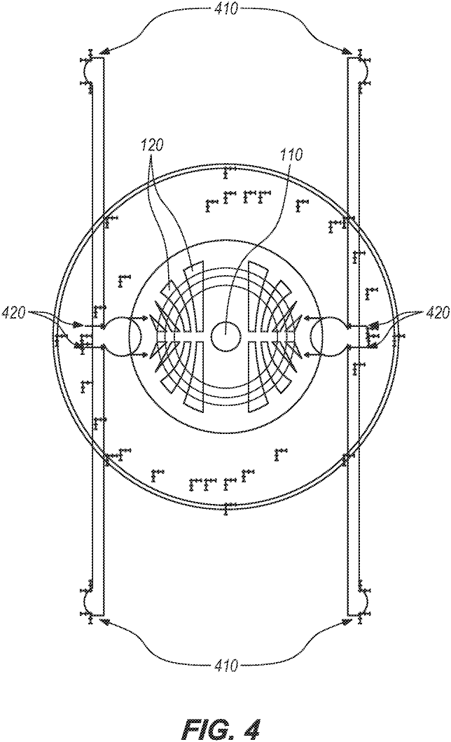

FIGS. 4-8 provide additional depictions of a flexible nozzle 100 and exit orifice 110 according to an embodiment. In FIG. 4, arrows 410 in a vicinity of opposing ends 203, 204 and 208, 209 of the depicted actuators 200, 205 indicate positions that are fixed relative to central contact surface 201 upon initiation of actuator deflection. Arrows 420 indicate force inputs that deform the nozzle 100 and hence the exit orifice 110.

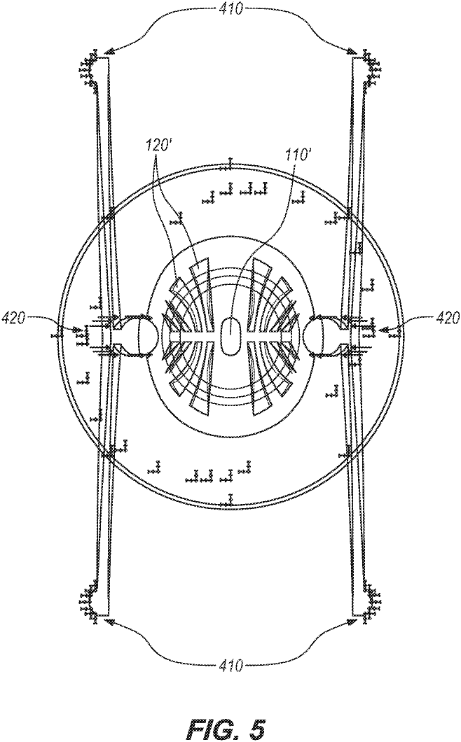

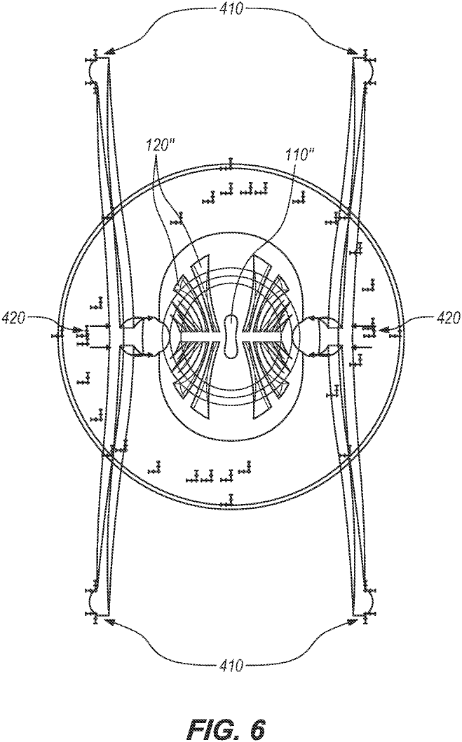

FIG. 5 depicts initial deflection of the flexible nozzle 100′ and in particular of the exit orifice 110′, showing a beginning of a change in shape of the exit orifice from circular to elliptical. FIG. 5 also depicts a beginning of change in shape of voids or strategic weaknesses 120′ in the nozzle 100. The arrows 410, 420 in FIG. 5 (and also FIGS. 6-8) signify the same things as do the arrows 410, 420 in FIG. 4.

FIG. 6 shows further deformation of the nozzle 100″ and exit orifice 110″ relative to FIG. 5, as well as further deformation of the voids and strategic weaknesses 120″. In FIG. 6, the exit orifice 110″ has the shape of an ellipse with its major and minor axes different from those of the elliptical exit orifice 110′ of FIG. 5. FIG. 6 shows an elliptical shape with a larger major axis and smaller minor axis than the elliptical shape of exit orifice 110″ in FIG. 5.

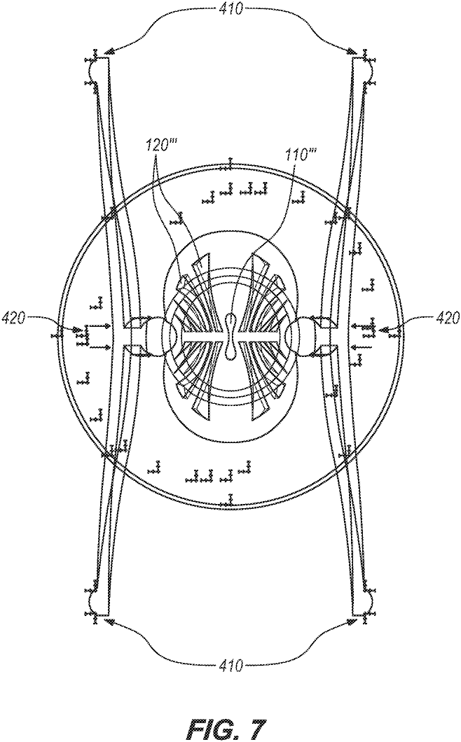

FIG. 7 shows still further deformation of the nozzle 100‴ and exit orifice 110‴, depicting near complete closure of the exit orifice 110‴,to the point that a center portion of the exit orifice 110‴ is pinched off or closed, so that there are effectively two exit orifices. As a result, the nozzle 100‴ in this configuration will emit two spray jets or fans. Ordinarily skilled artisans will appreciate that different shapes of central contact surfaces in the actuators, for example, wider or narrower with respect to exit orifice 110‴,can yield different types of configurations of the exit orifice 110‴,yielding different spray patterns. In the case of the type of deformation that FIG. 7 shows, the exit orifice 110‴ may be pinched off in more than one place, producing more than two spray jets or fans.

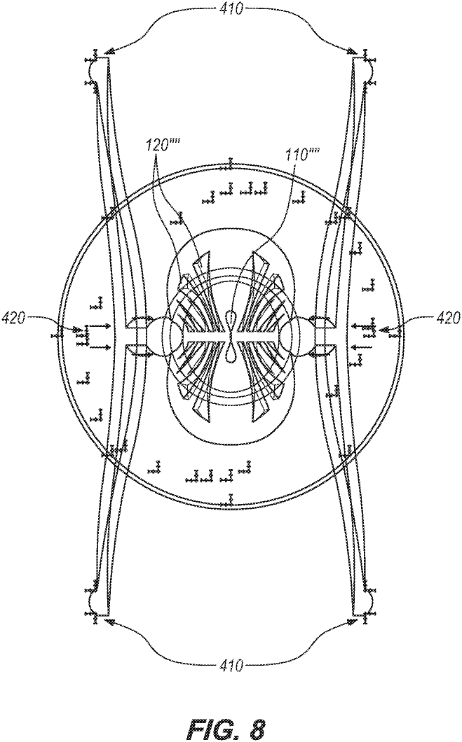

FIG. 8 shows the exit orifice 110⁗ closed. This closure may come at or near a maximum displacement of the actuators that urge the central contact surfaces toward the exit orifice. The effect here may be to cease spraying by pinching off the exit orifice, rather than changing fluid flow toward the exit orifice. In such an embodiment, the actuators and the nozzle can act as an on/off valve for spray. The speed at which the nozzle is completely closed, a rate at which the exit orifice is cycled from open to closed, and a relative time at which the nozzle is held open or held closed can be altered to achieve a desired intermittent flow.

The inventors have found that even small displacements of actuators (as small as or less than 1 mm) have been effective in altering desired spray features. In this regard, aspects of the invention can yield a 10:1 turndown ratio, as the exit orifice changes in size from an -01 orifice (defined in industry nomenclature as having a 0.1 gallons per minute flow rate at 40 pounds per square inch liquid pressure) to a -10 orifice (defined in industry nomenclature as having a 1.0 gallons per minute flow rate at 40 pounds per square inch liquid pressure). Referring to the addition of standard spraying PWM flow control mentioned above, a 5:1 to 6:1 turndown ratio that PWM control can add yields an overall turndown ratio of 60:1.

From the depictions in FIGS. 4-8, ordinarily skilled artisans will appreciate that the exit orifice 110 can start out in its original shape (circular, for example) and, as the amount of deformation increases, can become elliptical or can take on another shape or pattern of exit orifices, thus altering spray features, for example, spray shape, direction, flow rate, and droplet size, as well as spatial and/or temporal variations in these features. In an embodiment, the shape of exit orifice 110 may be varied substantially continuously to produce dynamic spray shapes, such as a “sweeping” spray pattern that moves back and forth, or a “split” spray pattern to address multiple targets.

In embodiments, when actuators which compress or deform nozzles are at rest, the actuator contact surfaces do not contact the nozzles. When initially actuated, the actuators may contact the nozzles, in some instances providing some degree of compression of exit orifices in the nozzles.

The sweeping pattern can be used to acquire a spray target as a vehicle or aircraft approaches a target, that is, to begin spraying the target as the vehicle or aircraft approaches the target. The sweeping pattern can maintain the spray on the target as the vehicle or aircraft passes over it and then continue to spray the target as the vehicle or aircraft travels away from the target. In this fashion, a high deposition rate of spray can be achieved on a target without the need for a high instantaneous flow rate of spray liquid during the brief period when the sprayer is directly over the target.

The split spray pattern can be used to direct spray patterns to different targets, for example, as a vehicle or aircraft passes over the targets. For example, in one type of precision spraying operation, a vehicle or aircraft can pass between or past different crop rows and target the rows, putting the spray where it is needed.

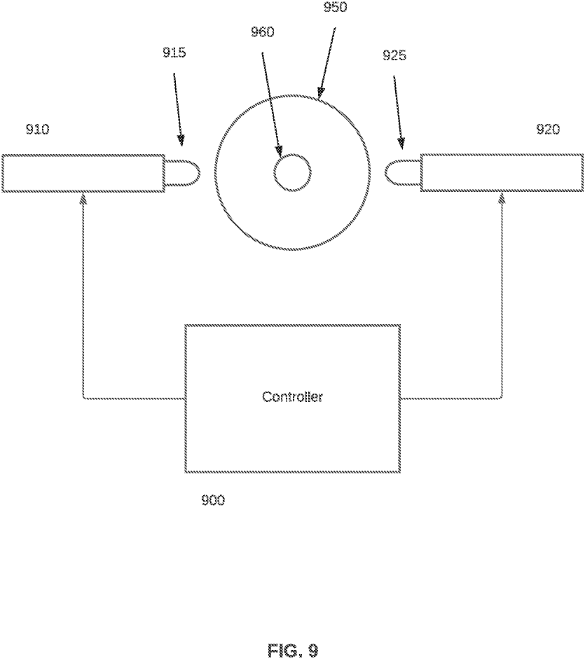

FIG. 9 is a high-level depiction of a dynamically controllable spray control system according to an embodiment. In FIG. 9, controller 900 controls respective actuators 910, 920 (shown here as in-line linear actuators) with respective contact edges 915, 925 which can move toward nozzle 950 to alter a shape of exit opening 960 or the associated through-hole in manners described previously. For ease of understanding, FIG. 9 does not show the voids or strategic weaknesses of previous figures. In an embodiment, there are no voids other than the through-hole and exit orifice, and there are no weaknesses. As with embodiments in earlier figures showing actuators, number, type, and positioning of actuators may vary as desired.

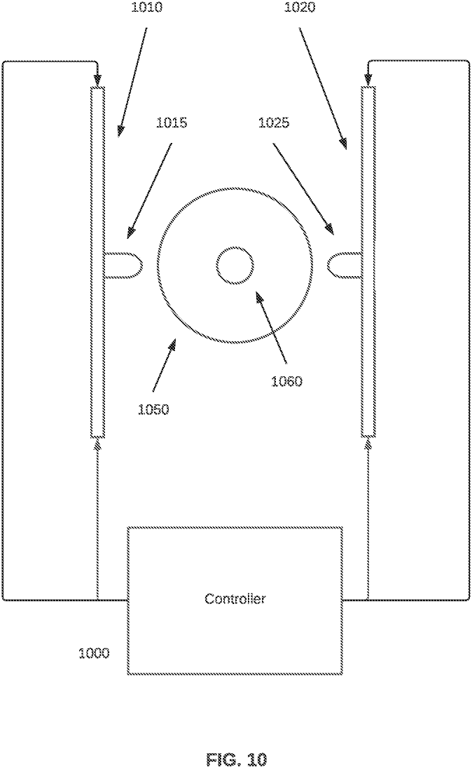

FIG. 10 is a high-level depiction of a dynamically controllable spray control system according to an embodiment. In FIG. 10, controller 1000 controls respective actuators 1010, 1020 (shown here as bender linear actuators) with respective central contact surfaces 1015, 1025 which can move toward nozzle 1050 to alter a shape of exit orifice 1060 or the associated through-hole in manners described previously. For ease of understanding, FIG. 10 does not show the voids or strategic weaknesses of previous figures. In an embodiment, there are no voids other than the through-hole and exit orifice, and there are no weaknesses. As with embodiments in earlier figures showing actuators, number, type, and positioning of actuators may vary as desired.

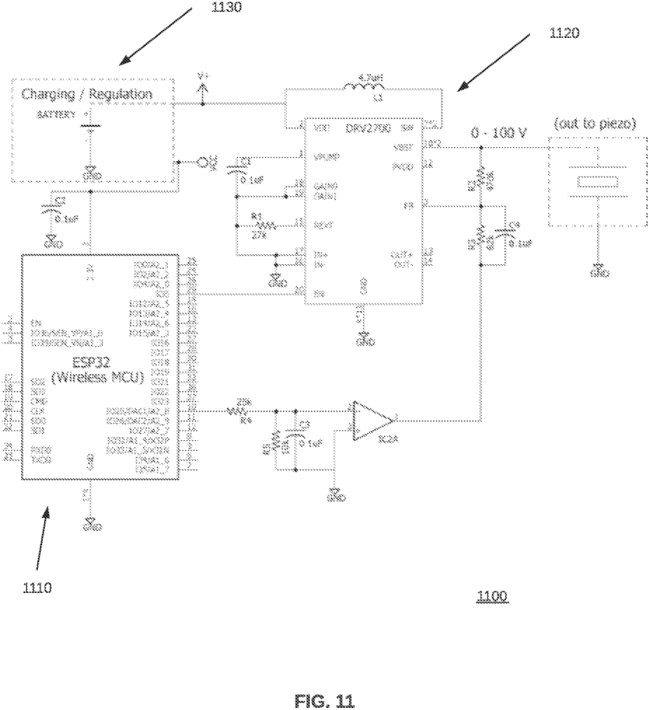

FIG. 11 is a diagram of a control circuit 1100 to communicate with and provide electronic control of the actuator(s) associated with a dynamically controllable spray nozzle. In FIG. 11, signals indicating desired actuator movement may be transmitted to controller 1110 which, in turn, decodes the signals into a command to create an output analog driving signal in driving circuit 1120 to an actuator. Such operation may be used to yield a desired amount of deformation/compression of the nozzle, including for example the nozzle opening.

In embodiments, command signals to the control circuit 1100 can come from a plurality of sources, including not only a console on board a vehicle or aircraft, but also, additionally or alternatively, an app on a phone or tablet, or a networked computer. In embodiments, control can be pre-programmed as a function of the area to be sprayed. In other embodiments, atmospheric conditions that could alter a shape and/or direction of spray, such as relative humidity, wind speed and/or direction, temperature, and the like, can be used to adjust the control signals being applied.

In an embodiment, the control circuit 1100 may be powered by a battery 1130, as shown. In an embodiment, the battery may be rechargeable or replaceable. In an embodiment, communication between the control circuit 1100 and the controlled linear actuator(s) may be performed wirelessly, avoiding a need for external cabling, connectors or wiring.

In an embodiment, the control circuit may receive power from sources other than a battery or other direct electrical connection, using a technique known as “energy harvesting”. For example, energy from vibrations of a vehicle carrying the control circuit and its associated nozzle(s), and/or from a boom on which the control circuit and associated nozzle(s) are mounted, may power the control circuit, avoiding a need for batteries or external power.

In embodiments, using actuators such as piezo-electric actuators can result in reduced actuator mass; lower power requirements (for example, on the order of milliwatts) but relatively high force (half a newton or more, for example); and improved response time.

In an embodiment, only one linear actuator may be used to create the displacement on one side of the flexible nozzle. That side remains pliant. An opposite side of the flexible nozzle may be more rigid or less pliant in order to provide a more solid portion against which the single linear actuator applies force to alter a shape of the exit orifice in the nozzle and thus provide a different spray shape and different alteration of droplet size.

The number and arrangement of actuators may be used to define the possible spray characteristics for a deformable nozzle. For example, an embodiment having two actuators positioned at a 90 degree angle with respect to each other will provide a different change in spray shape and/or direction, and different alteration of droplet size than would an embodiment having two actuators positioned opposite each other. Also, for example, in an embodiment having three or more linear actuators positioned either at regular or irregular intervals around the nozzle, will yield different changes in spray shape and/or direction and droplet sizes than would systems having other numbers or arrangements of actuators. Resulting nozzle shapes can be correspondingly complex (for example, non-circular or nonelliptical).

The figures in the present application depict actuator movement perpendicular to the nozzle through-hole to alter through-hole and/or exit orifice shape and size. In an embodiment, actuator movement may be at an angle other than 90 degrees, to effect different flow rates and pressures through the nozzle, and thus impart a different control aspect to the spray nozzle.

In an embodiment, instead of a central exit orifice, there may be a plurality of exit orifices, arranged for example in a line or another pattern, whether regular or irregular, at an exit side of the nozzle. Each exit orifice may have its associated actuator, or may in turn rely on one or more actuators. The use of a plurality of exit orifices, together with a plurality of actuators, can provide complex nozzle shapes and resulting flow rates, spray patterns and droplet sizes.

In an embodiment, instead of a single through-hole with a regular cylindrical shape, a through-hole of varying diameters may be provided. For example, the through-hole may have two or more diameters. Deforming the through-hole at one or more of those diameters will change a shape of the through-hole at each of those locations. This configuration may be thought of as an exit orifice with one or more pre- orifices. In an embodiment, a different linear actuator may be provided for each exit orifice or pre-orifice to provide complex nozzle shapes and resulting flow rates, spray patterns, and droplet sizes, and in some instances, a wider range of performance.

As noted previously, a single nozzle according to embodiments described herein can take the place of any number of rigid nozzles, providing the same range of angles, flow rates, spray patterns, and droplet sizes as multiple rigid nozzles, thereby avoiding the need to exchange nozzles during a spraying operation. Suitable control of the exit orifice opening enables this varied performance.

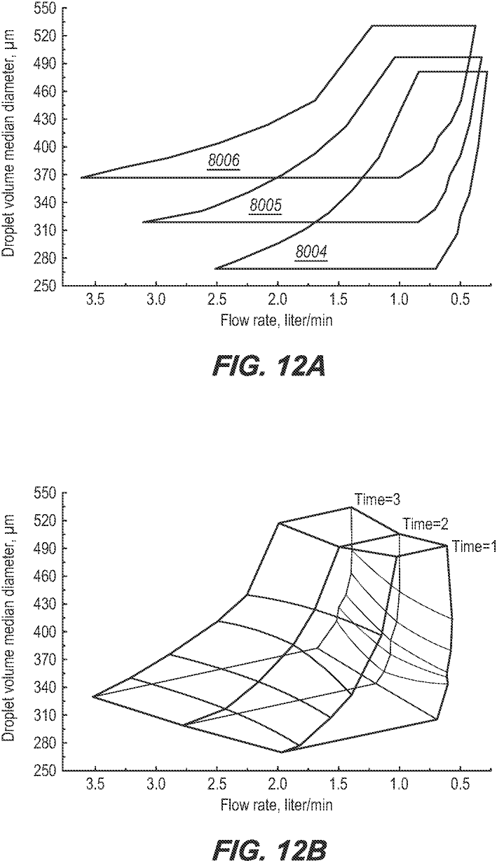

FIGS. 12A and 12B are graphs which demonstrate an example of this variety of performance. FIG. 12A shows graphs of possible flow rate versus droplet volume mean diameter (VMD) for three different static, fixed nozzles, each with the same spray pattern, but different exit orifice sizes. In FIG. 12A, each nozzle is coupled to a pulse width modulation (PWM) flow control valve upstream of the nozzle, intermittently allowing flow to entire the nozzle inlet. The variation of nozzle inlet pressure and pulsed flow defines the operating envelope of each fixed nozzle. Each nozzle has its own defined limits as to possible flow rate and droplet volume. The capabilities of the three static, fixed nozzles overlap to an extent, as shown in FIG. 12A. However, each nozzle has regions of unique performance, i.e., combinations of flow rate and droplet volume that can be achieved with this nozzle but not with the other two nozzles. As explained earlier, achieving the full range of performance with three discrete nozzles requires changing out one of those nozzles for another.

FIG. 12B shows a similar graph of possible flow rate versus droplet VMD for a deformable nozzle as described herein. The deformable nozzle also has defined limits as to possible flow rate and droplet VMD, but these limits encompass those of the three static, fixed nozzles as shown in FIG. 12A. This breadth of coverage is achieved by deformation of the nozzle over time, for example, from a state of deformation at time = 1 that approximates the capabilities of static, fixed nozzle 8004 in FIG. 12A, to a state of deformation at time = 2 that approximates the capabilities of static, fixed nozzle 8005 in FIG. 12A, to a state of deformation at time = 3 that approximates the capabilities of static, fixed nozzle 8006 in FIG. 12A. FIG. 12B thus depicts an example of range of performance of nozzles according to embodiments of the present invention.

It should be noted that the flat lower portions of each of the graphs in FIG. 12A may be a result of a practical limitation of minimum duty cycle of a PWM controller. As discussed above, providing PWM flow control to embodiments of the present invention can make it possible to extend those flat lower portions even lower. Such a relationship may be desirable, for example, in the course of low speed maneuvering of a sprayer, or during low speeds required while turning a sprayer. In an embodiment, coupling the above-described actuator operation with PWM flow control at an inlet of the nozzle can enlarge the overall spray control envelope of droplet volume median diameter as a function of flow rate.

In an embodiment, a plurality of deformable nozzles of the type described herein may be provided on a boom which is mounted on a piece of motorized equipment such as agricultural equipment which moves through a field. In another embodiment, the plurality of nozzles may be provided on a boom which is mounted on an airplane which traverses a field. In the case of airplane mounting, one or more of the actuators associated with a nozzle may be altered in position so as to bend the resulting stream from that nozzle at an angle from parallel to an airstream that the airplane provides. This bending of the stream may produce an altered droplet size, as ordinarily skilled artisans will appreciate from known relationships between nozzle angle, air speed, and droplet size.

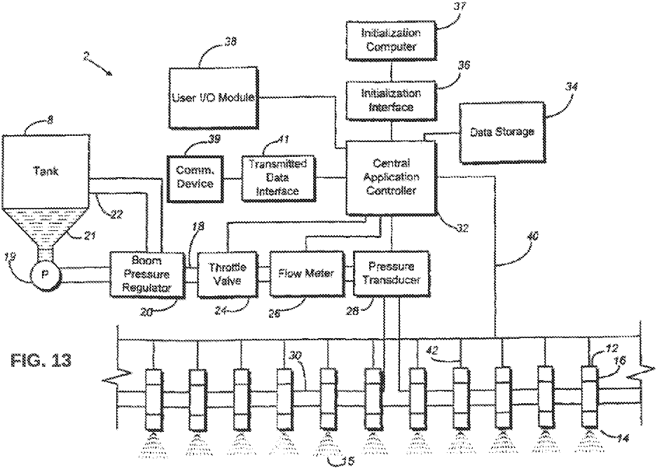

FIG. 13 shows an independent flow rate and droplet size control system 2, with a central application controller 32 including a microprocessor or microcontroller and appropriate volatile and/or nonvolatile storage components, among other things, as ordinarily skilled artisans will appreciate. The controller 32 is adapted to provide the normal functions associated with a microcomputer, including mathematical calculations, logic operations, data processing, and read/write operations to an appropriate transitory and/or non-transitory data storage device or component 34, and to execute various program instructions.

An initialization interface 36 connects the controller 32 to an initialization computer 37, which can comprise, for example, a portable computer or handheld device, including a tablet or smartphone running an appropriate program or app, used in the field for gathering data and the like. A user input/output module 38 receives various user inputs from a variety of input devices, and outputs data to a similarly wide range of output devices, as ordinarily skilled artisans will appreciate. A communications device 39 transmits and receives radio frequency and/or cellular transmissions or other wireless communications comprising operating information (e.g., ambient weather conditions, etc.) which are input to and output from the central application controller 32 through an interface 41. The components described thus far are commonly available and would be found in many microcomputer systems.

The controller 32 may communicate with nozzle assemblies 12 via a nozzle actuation bus 40 with a plurality of respective electrical leads 42 extending therefrom. In an embodiment, each nozzle assembly 12 may include an actuator assembly 16 as described herein, the actuator assembly 16 operating to open and close a respective deformable nozzle 14 also as described herein. In an embodiment, nozzle assemblies 12 may be interactive and networked for exchanging data among themselves and with the central application controller 32 by providing them with appropriate microprocessor components or chips. In addition to the components described above, the independent flow rate and droplet size control system 2 can include various other components as required for particular applications.

During a turn, a boom having a plurality of spray nozzles will have its innermost nozzle sweep slowly during a turn, but still must provide an accurate amount of spray to a target. In this fashion, the combination of a dynamically controllable nozzle according to embodiments, with PWM flow control, can provide greatly expanded spray control capability, for example, in terms of range of droplet size and flow rate.

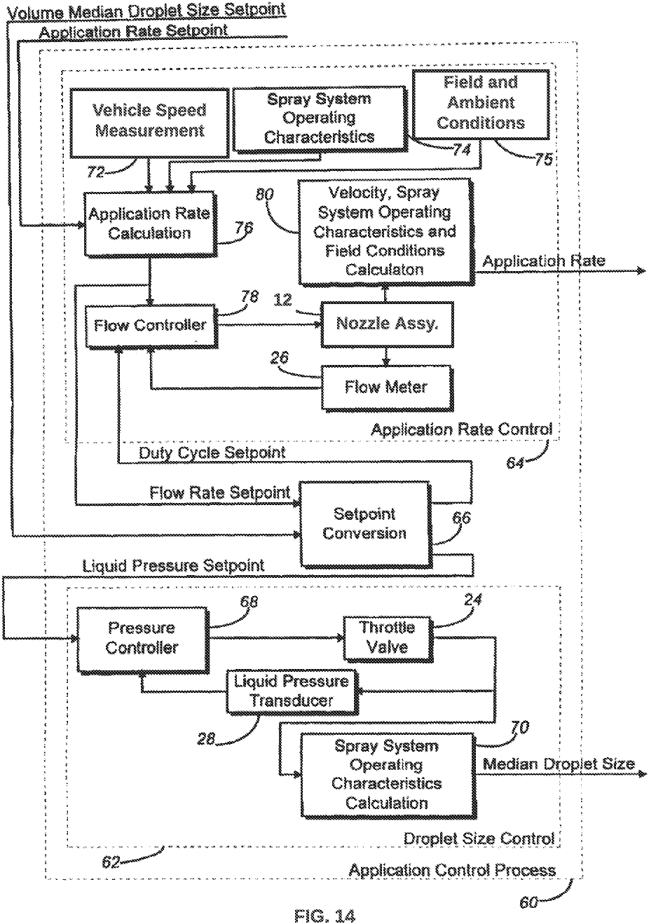

FIG. 14 shows an exemplary application control process 60 utilizing the central controller 32 for attaining a desired application rate setpoint and a volume median droplet (VMD) size setpoint. The flow rate and droplet size setpoint conversion subroutine 66 described above comprises a procedure or subroutine within the control process 60 shown in FIG. 14 to provide independent control of flow rate and droplet size.

The application control process 60 generally includes a droplet size control subsystem 62, an application rate control subsystem 64 and the setpoint conversion subroutine 66. The input data to the application control process 60 comprise, for example, a volume median droplet size setpoint and an application rate setpoint. In an embodiment, the input data may include some or all of the spray features described herein, including but not limited to flow rate, spray pattern, droplet size, and the like.

in an embodiment, the droplet size control subsystem 62 receives a liquid pressure setpoint, or the like, from the setpoint conversion subroutine 66 as described above, which is then input to a pressure controller 68. A throttle valve control signal is transmitted from the pressure controller 68 to the throttle valve 24, which opens or closes as necessary to a predetermined setting, which represents an approximation of the desired liquid pressure setpoint, as determined by the setpoint conversion subroutine 66. The droplet size control subsystem 62 is provided with a closed-loop correcting cycle which utilizes the liquid pressure transducer 28, the pressure controller 68 and the throttle valve 24 for making necessary corrections to achieve and maintain a desired liquid pressure.

The application control process 60 could receive a plurality of application rate setpoints and volume median droplet (VMD) size setpoints corresponding to a plurality of booms 10 or a plurality of nozzle assemblies 12. Such a control process system could be implemented by providing multiple droplet size control subsystems 62 and multiple application rate subsystems 64, each of which could be associated with a respective boom 10 or nozzle assembly 12. Other components, subsystems and subroutines of a spray system and its associated control system 2 therefor could be provided in appropriate multiples to implement independent and selective control of application rate setpoints and volume median droplet (VMD) size setpoints of corresponding pluralities of booms 10 or nozzle assemblies 12.

As shown in FIG. 14, the volume median droplet size is a function of liquid pressure and system characteristics, which are factored in at 70 and can include such factors as characteristics of nozzle 14, properties of liquid being applied, and various other factors such as characteristics of the agricultural sprayer (which may include not only the spray system with its control system 2, but also the vehicle or craft on which the spray system is mounted) and ambient conditions. Data for calculating the effects of the spray system characteristics 70 on the droplet size can be stored in the flow rate and droplet size control system 2, for example, in the read/write data storage device 34 thereof, and can be input with the user input/output module 38.

In embodiments, the vehicle or craft mentioned herein may be human-controlled either directly (by actual operation by a human) or remotely (via a computer or handheld device, for example, using one or more apps). In embodiments, the vehicle or craft may be autonomous.

The application rate setpoint may be input to an application rate calculation 76, which also receives input data comprising a groundspeed measurement 72 of the spray vehicle or craft 6, for example, from a groundspeed measuring device on the vehicle or device, or from a GPS source (as described later), and spray system operating characteristics 74 such as number, spacing and configuration of nozzles 14, width and height of boom 10, and other conditions. The spray system operating characteristics 74 are particularly significant when the vehicle or craft comprises an aircraft, which can be located at different altitudes above a field. Such spray system characteristics 74 can be derived from the read/write data storage device 34, or provided in any other suitable manner. In an embodiment, field and ambient conditions 75 also may be input to the application rate calculation 76.

The application rate calculation 76 transmits a signal to the flow controller 78, and a flow rate setpoint to the setpoint conversion subroutine 66 as described above. The flow controller 78 can include a function generator and amplifier system such as that described in USP 5,134,961, or any other suitable function generator. The signals output by the flow controller 78 are distributed to the nozzle assemblies 12 (which include deformable nozzles as described herein and other nozzle features, for example, valves, for which control may be integrated in any appropriate matter, for example, in parallel) by the individual nozzle leads 42, which collectively form a nozzle bus 40.

The application rate control subsystem 64 includes a closed-loop flow rate correcting system including the flow controller 78, the nozzle assembly(ies) 12 and the flow meter 26 whereby the flow controller 78 receives an initial or anticipated approximate duty cycle setpoint from the setpoint conversion subroutine 66. Continuous corrections are made to the flow rate by altering the duty cycle signals output to the nozzle assemblies 12. It will be appreciated that the duty cycle signals transmitted by the flow controller 78 can range from a relatively low or zero percentage of “open nozzle” time to a relatively high percentage, or even a continuously open condition of the nozzles 14.

The effects of additional factors on the application rate, such as groundspeed or airspeed of a spray vehicle or craft, spray system operating characteristics 74 (including for example characteristics of the nozzles 14 and/or booms 10 and/or feedback on system operation, e.g. indications of nozzle clogs), and field and ambient conditions 75 are taken into account in calculating the application rate at 76 and/or in performing the calculations of velocity, spray system operating characteristics, and field conditions at 80.

As noted above, the application rate and the droplet size setpoints can be adjusted selectively and independently of each other, with the central application controller 32, and more specifically its setpoint conversion subroutine 66, providing the necessary adjustments to the pressure and duty cycle setpoints by means of the pressure controller 68 and/or throttle valve 24, and the flow controller 78, respectively. It will be appreciated that the application control process 60 can be implemented with the control system 2 including the controller 32, or with any other suitable control system, such as another type of programmable controller.

In embodiments, the control systems in either or both of FIGS. 13 and 14 have storage and processing capability to create a spray application record comprising data selected from the group consisting of nozzle shape, pressure, and PWM flow control characteristics, along with vehicle or craft data (position, altitude, speed, direction, and the like) and atmospheric conditions (temperature, relative humidity, wind speed, precipitation, and the like).

An expanded spray control capability such as the one just discussed, in conjunction with spray nozzles according to embodiments of the invention, can accommodate a wider range of sprayer travel speed and spray strategies through normal high-speed operation and through required low-speed maneuvers. An example of a low-speed maneuver would occur during deceleration at the end of a row being sprayed, when a turn is required. Performing the turn itself may involve a number of individual controls of nozzles on a boom, in which nozzles toward an inner radius of the boom would cover less area (and thus would entail less spray flow), while nozzles toward an outer radius of the boom would cover more area (and thus would entail more spray flow).

In an embodiment, the displacement of the actuators can be initiated by the detection of an undesired condition of the spray nozzle, for example, a partially or completely clogged nozzle in which the flow rate, spray pattern, and/or droplet size may be undesirably altered, e.g. away from optimal or defined conditions. Such undesirable condition may be detected, for example, by observing changes in one or more of pressure, flow, vibration, sound or optical appearance of the spray. In this circumstance, embodiments according to the invention can control actuator operation to cycle through different opening sizes of the exit orifice and/or through-hole. The cycling can help to clear an obstruction without the operator having to perform a declogging operation that can interrupt operations, for example, by inspection, manual declogging, and/or nozzle replacement. Ordinarily skilled artisans will appreciate that aerial spraying operations can make such declogging operations impractical. In some embodiments, such actuator operation can provide a vibratory motion to the nozzle to help clear the exit orifice and/or through-hole. Other embodiments may control actuator operation to open or stretch the exit orifice and/or through-hole to allow the obstruction to clear. Still other embodiments may provide relaxation of the exit orifice in combination with a timed upstream pressure surge or pressure wave that, when used with a plurality of nozzles on a boom, can target a specific location of the clogged nozzle. In this manner, it is possible to clear the obstruction while not interrupting spray operations or requiring human intervention and risk of chemical exposure during a manual unclogging task.

The following paragraphs (1)-(67)describe non-limiting embodiments in accordance with the invention:

Paragraph (1): In some embodiments of the invention, a controllable spray nozzle comprises: a deformable material with a through-hole for passing liquid therethrough and an exit orifice, the deformable material enabling alteration of a shape of at least one of the through-hole and the exit orifice in response to deformation in one or more directions; wherein the deformation changes a shape of the at least one of the through-hole and the exit orifice to change a spray exiting from the spray nozzle.

Paragraph (2): In some embodiments of the invention, including but not limited to those described in paragraph (1), the deformation changes a shape of the through-hole in response to the deformation in one or more directions.

Paragraph (3): In some embodiments of the invention, including but not limited to those described in each of paragraph (1) or paragraph (2), the deformation changes a shape of the exit orifice in response to the deformation in one or more directions.

Paragraph (4): In some embodiments of the invention, including but not limited to those described in each of paragraphs (1)-(3), the deformation changes a shape of the through-hole to change one or more of a flow rate, a spray pattern, and a droplet size exiting from the spray nozzle.

Paragraph (5): In some embodiments of the invention, including but not limited to those described in each of paragraphs (1)-(4), the deformation changes a shape of the exit orifice to change one or more of a flow rate, a spray pattern, and a droplet size exiting from the spray nozzle.

Paragraph (6): In some embodiments of the invention, including but not limited to those described in each of paragraphs (1)-(5), the deformation changes a shape of the exit orifice to change a direction of spray exiting from the spray nozzle.

Paragraph (7): In some embodiments of the invention, including but not limited to those described in each of paragraphs (1)-(6), the deformation is provided along two perpendicular axes with respect to the through-hole.

Paragraph (8): In some embodiments of the invention, including but not limited to those described in each of paragraphs (1)-(6), the deformation is provided along an axis that is perpendicular with respect to the through-hole.

Paragraph (9): In some embodiments of the invention, including but not limited to those described in each of paragraphs (1)- (8), the deformable material enables alteration of a shape of the exit orifice in response to the deformation in one or more directions; and the deformation includes changing a shape of the exit orifice.

Paragraph (10): In some embodiments of the invention, including but not limited to those described in each of paragraphs (1)-(9), herein the deformable material enables alteration of a shape of the through-hole in response to deformation in one or more directions; and the deformation includes changing a shape of the through-hole.

Paragraph (11): In some embodiments of the invention, including but not limited to those described in each of paragraphs (1)-(10), the spray nozzle is an agricultural spray nozzle.

Paragraph (12): In some embodiments of the invention, including but not limited to those described in each of paragraphs (1)-(11), the deformable material comprises elastomers having a Shore A hardness of 40 to 90.

Paragraph (13): In some embodiments of the invention, including but not limited to those described in each of paragraphs (1)-(12), the deformable material comprises two or more materials having non-homogeneous and/or anisotropic properties and/or nonlinear properties, to provide nonlinear deformability of the deformable material.

Paragraph (14): In some embodiments of the invention, including but not limited to those described in each of paragraphs (1)-(13), the exit orifice is circular, and the deformation changes a shape of the exit orifice to be elliptical with a variable major axis and a variable minor axis.

Paragraph (15): In some embodiments of the invention, including but not limited to those described in each of paragraphs (1)-(14), the through-hole is cylindrical, and the deformation changes a shape of the through-hole to have an elliptical cross-section with a variable major axis and a variable minor axis.

Paragraph (16): In some embodiments of the invention, including but not limited to those described in each of paragraphs (1)-(15), the through-hole has two or more diameters, and the deformation changes a shape of the through-hole at each of the two or more diameters.

Paragraph (17): In some embodiments of the invention, including but not limited to those described in each of paragraphs (1)-(16), the nozzle is provided with a plurality of voids or strategic weaknesses to alter how the deformation is provided.

Paragraph (18): In some embodiments of the invention, including but not limited to those described in each of paragraphs (1)-(17), the deformation is provided at the exit orifice.

Paragraph (19): In some embodiments of the invention, including but not limited to those described in each of paragraphs (1)-(18), the deformation is provided along a length of the through-hole.

Paragraph (20): In some embodiments of the invention, a spray nozzle system comprises: a spray nozzle as described in any of paragraphs (1)-(19); at least one actuator to provide the deformation; and a controller to provide signals to the at least one actuator to provide the deformation on at least one side of the spray nozzle.

Paragraph (21): In some embodiments of the invention, a spray nozzle system comprises: a deformable material with a through-hole for passing liquid therethrough and an exit orifice, the deformable material enabling alteration of a shape of at least one of the through-hole and the exit orifice in response to deformation in one or more directions; wherein the deformation changes a shape of the at least one of the through-hole and the exit orifice to change a spray exiting from the spray nozzle; and the system further comprises: at least one actuator to provide the deformation; and a controller to provide signals to the at least one actuator to provide the deformation on at least one side of the spray nozzle.

Paragraph (22): In some embodiments of the invention, including but not limited to those described in each of paragraph (20) or paragraph (21), the actuator comprises at least one contact surface to contact the spray nozzle to provide the deformation.

Paragraph (23): In some embodiments of the invention, including but not limited to those described in each of paragraphs (20)-(22), the deformation changes a shape of the through-hole in response to the deformation in one or more directions.

Paragraph (24): In some embodiments of the invention, including but not limited to those described in each of paragraphs (20)-(23), the deformation changes a shape of the through-hole in response to the deformation in one or more directions.

Paragraph (25): In some embodiments of the invention, including but not limited to those described in each of paragraphs (20)-(24), the deformation changes a shape of the exit orifice in response to the deformation in one or more directions.

Paragraph (26): In some embodiments of the invention, including but not limited to those described in each of paragraphs (20)-(25), the deformation changes a shape of the through-hole to change one or more of a flow rate, a spray pattern, and a droplet size exiting from the spray nozzle.

Paragraph (27): In some embodiments of the invention, including but not limited to those described in each of paragraphs (20)-(26), the deformation changes a shape of the exit orifice to change one or more of a flow rate, a spray pattern, and a droplet size exiting from the spray nozzle.

Paragraph (28): In some embodiments of the invention, including but not limited to those described in each of paragraphs (20)-(27), the deformation changes a shape of the exit orifice to change a direction of spray exiting from the spray nozzle.

Paragraph (29): In some embodiments of the invention, including but not limited to those described in each of paragraphs (20)-(28), the deformation is provided along two perpendicular axes with respect to the through-hole.

Paragraph (30): In some embodiments of the invention, including but not limited to those described in each of paragraphs (20)-(28), the deformation is provided along a single axis with respect to the through-hole.

Paragraph (31): In some embodiments of the invention, including but not limited to those described in each of paragraphs (20)-(30), the deformable material further enables alteration of a shape of the exit orifice in response to the deformation in one or more directions; and the deformation includes changing a shape of the through-hole.

Paragraph (32): In some embodiments of the invention, including but not limited to those described in each of paragraphs (20)-(31), the deformable material further enables alteration of a shape of the through-hole in response to deformation in one or more directions; and the deformation includes changing a shape of the through-hole.

Paragraph (33): In some embodiments of the invention, including but not limited to those described in each of paragraphs (20)-(32), the spray nozzle is an agricultural spray nozzle.

Paragraph (34): In some embodiments of the invention, including but not limited to those described in each of paragraphs (20)-(33), the deformable material comprises elastomers having a Shore A hardness of 40 to 90.

Paragraph (35): In some embodiments of the invention, including but not limited to those described in each of paragraphs (20)-(34), the deformable material comprises two more materials having non-homogeneous and/or anisotropic properties and/or nonlinear properties, to provide nonlinear deformability of the deformable material.

Paragraph (36): In some embodiments of the invention, including but not limited to those described in each of paragraphs (20)-(35), the exit orifice is circular, and the deformation changes a shape of the exit orifice to be elliptical with a variable major axis and a variable minor axis.

Paragraph (37): In some embodiments of the invention, including but not limited to those described in each of paragraphs (20)-(36), the through-hole is cylindrical, and the deformation changes a shape of the through-hole to have an elliptical cross-section with a variable major axis and a variable minor axis.

Paragraph (38): In some embodiments of the invention, including but not limited to those described in each of paragraphs (20)-(37), the through-hole has two or more diameters, and the deformation changes a shape of the through-hole at each of the two or more diameters.

Paragraph (39): In some embodiments of the invention, including but not limited to those described in each of paragraphs (20)-(38), the spray nozzle is provided with a plurality of voids or strategic weaknesses to alter how the deformation is provided.

Paragraph (40): In some embodiments of the invention, including but not limited to those described in each of paragraphs (20)-(39), the deformation is provided at the exit orifice.

Paragraph (41): In some embodiments of the invention, including but not limited to those described in each of paragraphs (20)-(40), the deformation is provided along a length of the through-hole.

Paragraph (42): In some embodiments of the invention, including but not limited to those described in each of paragraphs (20)-(41), the at least one actuator comprises at least one linear actuator.

Paragraph (43): In some embodiments of the invention, including but not limited to those described in each of paragraphs (20)-(42), the at least one actuator comprises a pair of actuators to provide the deformation along axes perpendicular to the through-hole.

Paragraph (44): In some embodiments of the invention, including but not limited to those described in each of paragraphs (20)-(43), the at least one actuator comprises a pair of actuators to provide the deformation along collinear axes perpendicular to the through-hole.

Paragraph (45): In some embodiments of the invention, including but not limited to those described in each of paragraphs (20)-(44), the at least one actuator comprises a pair of actuators to provide the deformation on two sides of the spray nozzle.

Paragraph (46): In some embodiments of the invention, including but not limited to those described in each of paragraphs (20)-(45), the controller controls a movement of at least one actuator contact surface toward and away from the spray nozzle in a direction perpendicular to the through-hole.

Paragraph (47): In some embodiments of the invention, including but not limited to those described in each of paragraphs (20)-(45), the controller controls a movement of at least one actuator contact surface toward and away from the spray nozzle in a direction not perpendicular to the through-hole.

Paragraph (48): In some embodiments of the invention, including but not limited to those described in each of paragraphs (20)-(47), the controller detects an obstruction in one or more of the through-hole and the exit orifice, and controls a movement of the at least one actuator contact surface toward and away from the spray nozzle to enable dislodging of the obstruction from one or more of the through-hole and the exit orifice.

Paragraph (49): In some embodiments of the invention, including but not limited to those described in each of paragraphs (20)-(48), the controller controls a movement of at least one actuator contact surface toward and away from the spray nozzle to enable dislodging of an obstruction from one or more of the exit orifice and the through-hole.

Paragraph (50): In some embodiments of the invention, including but not limited to those described in each of paragraphs (20)-(49), the system further comprises a pulse width modulation (PWM) control system upstream of an inlet to the spray nozzle, the controller and the PWM control system controlling the deformation to enlarge a spray control envelope of droplet volume median diameter as a function of flow rate.

Paragraph (51): In some embodiments of the invention, including but not limited to those described in paragraph (50), the PWM flow control system includes the controller.

Paragraph (52): In some embodiments of the invention, including but not limited to those described in each of paragraph (50) or paragraph (51), the PWM flow control system responds to at least one of field conditions or ambient conditions to provide the control signals to the at least one actuator.

Paragraph (53): In some embodiments of the invention, a method of controlling a spraying system that includes a spray nozzle as described in any of paragraphs (1)-(19) comprises: providing signals to at least one actuator to move at least one actuator contact surface toward and away from the spray nozzle; moving the at least one actuator contact surface to deform the spray nozzle in one or more directions; the moving changing a shape of one or more of the through-hole and the exit orifice to change a spray exiting from the spray nozzle.

Paragraph (54): In some embodiments of the invention, a method of controlling a spraying system that includes a spray nozzle comprising a deformable material with a through-hole for passing liquid therethrough and an exit orifice, comprises: providing signals to at least one actuator to move at least one actuator contact surface toward and away from the spray nozzle; moving the at least one actuator contact surface to deform the spray nozzle in one or more directions; the moving changing a shape of one or more of the through-hole and the exit orifice to change a spray exiting from the spray nozzle.

Paragraph (55): In some embodiments of the invention, including but not limited to those described in each of paragraph (53) or paragraph (54), the method further comprises providing signals to a plurality of actuators to move a plurality of actuator contact surfaces to deform the spray nozzle in a plurality of directions.

Paragraph (56): In some embodiments of the invention, including but not limited to those described in each of paragraphs (53)-(55), the method further comprises providing signals to a pair of actuators to move a pair of actuator contact surfaces to deform the spray nozzle in two directions.

Paragraph (57): In some embodiments of the invention, including but not limited to those described in each of paragraphs (53)-(56), the two directions are collinear.

Paragraph (58): In some embodiments of the invention, including but not limited to those described in each of paragraphs (53)-(56), the two directions are perpendicular.

Paragraph (59): In some embodiments of the invention, including but not limited to those described in each of paragraphs (53)-(58), the moving comprises moving the at least one actuator contact surface toward and away from the spray nozzle in a direction perpendicular to the through-hole.

Paragraph (60): In some embodiments of the invention, including but not limited to those described in each of paragraphs (53)-(59), the moving comprises moving the at least one actuator contact surface toward and away from the spray nozzle in a direction not perpendicular to the through-hole.

Paragraph (61): In some embodiments of the invention, including but not limited to those described in each of paragraphs (53)-(60), the method further comprises detecting an obstruction in one or more of the through-hole and the exit orifice, and moving the at least one actuator contact surface toward and away from the spray nozzle to enable dislodging of the obstruction from one or more of the through-hole and the exit orifice.

Paragraph (62): In some embodiments of the invention, including but not limited to those described in each of paragraphs (53)-(61), the moving comprises moving the at least one actuator contact surface toward and away from the spray nozzle to enable dislodging of an obstruction from one or more of the exit orifice and the through-hole.

Paragraph (63): In some embodiments of the invention, including but not limited to those described in each of paragraphs (53)-(62), the method further comprises coordinating the deformation with an operating state of a PWM flow control system upstream of an inlet to the spray nozzle to enlarge a spray control envelope of droplet volume median diameter as a function of flow rate.

Paragraph (64): In some embodiments of the invention, including but not limited to those described in paragraph (63), the operating state of the PWM flow control system responds to at least one of field conditions or ambient conditions.

Paragraph (65): In some embodiments of the invention, including but not limited to those described in each of paragraphs (53)-(64), the method further comprises creating, using a controller-based system as described in each of paragraphs (20)-(52), a spray application record comprising data selected from the group consisting of spray nozzle shape, pressure, PWM flow control characteristics, data regarding a vehicle or craft on which the controller-based system as claimed in each of paragraphs (20)-(52) is mounted, and one or more atmospheric conditions.

Paragraph (66): In some embodiments of the invention, including but not limited to those described in paragraph (65), the vehicle or craft data is selected from the group consisting of position, altitude, speed, and direction.

Paragraph (67): In some embodiments of the invention, including but not limited to those described in paragraph (65), the atmospheric condition data is selected from the group consisting of temperature, relative humidity, wind speed, and precipitation.

While the foregoing discussion describes aspects of the present invention according to various embodiments, ordinarily skilled artisans will appreciate that variations within the scope and spirit of the invention are possible. Accordingly, the invention should be considered as limited only by the scope of the following claims.

What is claimed is:

1. A controllable spray nozzle comprising:
a deformable material with a through-hole for passing liquid therethrough and an exit orifice, the deformable material enabling alteration of a shape of at least one of the through-hole and the exit orifice in response to deformation in one or more directions;
wherein the deformation changes a shape of the at least one of the through-hole and the exit orifice to change a spray exiting from the spray nozzle.

2. The spray nozzle as claimed in claim 1, wherein the deformation changes a shape of at least one of the through-hole and the exit orifice to change one or more of a flow rate, a spray pattern, and a droplet size exiting from the spray nozzle.

3. The spray nozzle as claimed in claim 1, wherein the deformation changes a shape of at least one of the through-hole and the exit orifice to change a direction of spray exiting from the spray nozzle.

4. The spray nozzle as claimed in claim 1, wherein the deformation is provided along one or more axes that are perpendicular with respect to the through-hole axis.

5. The spray nozzle as claimed in claim 1, wherein the spray nozzle is an agricultural spray nozzle.

6. The spray nozzle as claimed in claim 1, wherein the deformable material comprises two or more materials having non-homogeneous and/or anisotropic properties and/or nonlinear properties, to provide nonlinear deformability of the deformable material.

7. The spray nozzle as claimed in claim 1, wherein the deformation changes a shape of one of the exit orifice and the through-hole to be elliptical with a variable major axis and a variable minor axis.

8. The spray nozzle as claimed in claim 1, wherein the through-hole has two or more diameters, and the deformation changes a shape of the through-hole at each of the two or more diameters.

9. The spray nozzle as claimed in claim 1, wherein the nozzle is provided with a plurality of voids or strategic weaknesses to alter how the deformation is provided.

10. A spray nozzle system comprising:
an agricultural spray nozzle comprising:
a deformable material with a through-hole for passing liquid therethrough and an exit orifice, the deformable material enabling alteration of a shape of at least one of the through-hole and the exit orifice in response to deformation in one or more directions;
wherein the deformation changes a shape of the at least one of the through-hole and the exit orifice to change a spray exiting from the spray nozzle;
the system further comprising:
at least one actuator to provide the deformation; and
a controller to provide signals to the at least one actuator to provide the deformation on at least one side of the spray nozzle.

11. The system as claimed in claim 10, wherein the actuator comprises at least one contact surface to contact the spray nozzle to provide the deformation.

12. The system as claimed in claim 10, wherein the at least one actuator comprises at least one actuator to provide the deformation along at least one axis that is at an angle relative to an axis of the through-hole.

13. The system as claimed in claim 10, wherein the at least one actuator comprises a pair of actuators to provide the deformation on two sides of the spray nozzle.

14. The system as claimed in claim 11, wherein the controller controls a movement of at least one actuator contact surface toward and away from the spray nozzle to enable dislodging of an obstruction from one or more of the exit orifice and the through-hole.

15. The system as claimed in claim 10, further comprising a pulse width modulation (PWM) control system upstream of an inlet to the agricultural spray nozzle, wherein the controller and the PWM control system control the deformation to enlarge a spray control envelope of droplet volume median diameter as a function of flow rate.

16. The system as claimed in claim 15, wherein the PWM flow control system responds to at least one of sprayer, field conditions or ambient conditions to provide the control signals to the at least one actuator.

17. A method of controlling a spraying system that includes a spray nozzle comprising a deformable material with a through-hole for passing liquid therethrough and an exit orifice, the method comprising:
providing signals to at least one actuator to move at least one actuator contact surface toward and away from the spray nozzle;
moving the at least one actuator contact surface toward and away from the spray nozzle to deform the spray nozzle in one or more directions;
the moving changing a shape of one or more of the through-hole and the exit orifice to change a spray exiting from the spray nozzle.

18. The method as claimed in claim 17, further comprising providing signals to a pair of actuators to move a pair of actuator contact surfaces toward and away from the spray nozzle to deform the spray nozzle in two directions.

19. The method as claimed in claim 17, further comprising detecting an obstruction in one or more of the through-hole and the exit orifice, and moving the at least one actuator contact surface toward and away from the spray nozzle to enable dislodging of the obstruction from one or more of the through-hole and the exit orifice.

20. The method as claimed in claim 19, further comprising creating, using a controller-based system as claimed in claim 11, a spray application record comprising data selected from the group consisting of spray nozzle shape, pressure, PWM flow control characteristics, data regarding a vehicle or craft on which the controller-based system as claimed in claim 11 is mounted, and one or more atmospheric conditions,
wherein the vehicle or craft data is selected from the group consisting of position, altitude, speed, and direction; and
wherein the atmospheric condition data is selected from the group consisting of temperature, relative humidity, wind speed, wind direction, and precipitation.
